(19) United States
(12) Patent Application Publication
(10) Pub. No.: US 2004/0000339 A1
(43) Pub. Date: Jan. 1, 2004

(54) Multiple dispensing check valve delivery system

(76) Inventor: Douglas Charles Heiderman, Akron, NY (US)

Correspondence Address: PRAXAIR, INC., LAW DEPARTMENT - M1 557, 39 OLD RIDGEBURY ROAD, DANBURY, CT, 06810-5113, US

(21) Appl. No.: 10/342,255

(22) Filed: Jan. 15, 2003

Related U.S. Application Data
(63) Continuation-in-part of application No. 10/184,987, filed on Jul. 1, 2002.

(51) Int. Cl. F16K 31/12

(52) U.S. Cl. 137/494

(57) ABSTRACT

This invention is directed to an apparatus for controlling the discharge of pressurized fluids from the outlet of a pressurized vessel, and particularly directed to multiple fluid dispensing check valve devices within the vessel for storing and controlling the flow of fluid or gases out of the vessel.

This application is a continuation-in-part of prior U.S. application Ser. No. 10/184,987, filed Jul 1, 2002.

### FIELD OF THE INVENTION

This invention relates to a valve assembly for storing and dispensing fluids, and more particularly, this invention relates to a multiple delivery valve assembly for storing and dispensing pressurized gases, and which prevents uncontrolled discharge of the pressurized gases from a vessel.

### BACKGROUND OF THE INVENTION

It has been a goal in the industry to provide a safe and effective way to handle toxic, flammable, corrosive gases at sub-atmospheric conditions. In particular, these gases include dopant gases. Generally, dopant gases are stored in compressed gas cylinders at pressures equal to the individual gases'vapor pressure at a given or at a specific pressure depending upon the properties of the specific gas. The gases serve as a source of dopant material for the manufacturing of semiconductor devices. These dopant gases are used in a tool called an ion implanter. Ion implanters are located within the fabrication area of a semiconductor production facility where several hundreds or even thousands of personnel are engaged in the semiconductor manufacturing process. These tools are operated at very high voltages, typically up to several thousand kilovolts. Due to these high voltages, the dopant source gases must be located at or within the tool itself (most other semiconductor tools locate source gases outside of the personnel or main production area). One distinct characteristic of the ion implant tools is that they operate at sub-atmospheric pressure. Utilization of the vacuum present at the tool to delivery product from the cylinder creates a safer package in that product cannot be removed from the cylinder package until a vacuum is applied. This vacuum delivery concept prevents accidental exposure to the pressurized gas.

Currently, there are believed to be four distinct methods for solving the problems associated with the sub-atmospheric delivery of dopant gases. The first involves filling a compressed gas cylinder with a physical adsorbent material (such as beaded activated carbon), and reversibly adsorbing the dopant gases onto the material. This concept is commonly known as the SDS™ technology. The desorption process involves applying a vacuum or heat to the adsorbent material/cylinder. In practice, vacuum from the ion implanter is used to desorb the gas from the solid-phase adsorbent. There are certain limitations associated with the problems with the SDS technology, and they include: 1) the adsorbent material has a finite loading capacity thereby limiting the amount. of product available in a given size cylinder; 2) the desorption process can be initiated by exposing the cylinder package to heat, thereby causing the cylinders to reach and deliver gases at atmospheric and super-atmospheric pressures when the cylinder is exposed to temperatures greater than 70 degrees F., which are common in many cylinder warehouse locations; 3) the purity of the gas delivered from the cylinder can be compromised due to adsorption/desorption of the other materials/gases on the adsorbent material; and 4) adsorbent attrition can lead to particulate contamination in the gas delivery system.

A second method for solving the problems associated with the sub-atmospheric delivery of dopant gases involves the use of a mechanical check valve to deliver the product sub-atmospherically. This device is configured to open when sub-atmospheric or vacuum conditions are applied to the device. The device is located upstream of a conventional on/off cylinder valve seat mechanism. The exact location of this upstream device can be in the valve body, in the cylinder neck cavity, inside the cylinder itself, or combinations of all three locations. In each case the device is located upstream of the cylinder valve seat with respect to flow of gas from the interior of the cylinder to the delivery port.

U.S. Pat. No. 5,937,895 discloses a check valve in the form of a vacuum actuated dispensing check valve and a flow restriction arrangement to provide a virtually fail safe system for preventing hazardous discharge of fluid from a pressurized cylinder or tank. U.S. Pat. No. 6,045,115 discloses a flow restrictor to provide a capillary size opening that minimizes any discharge of toxic gases from compressed gas cylinders in the unlikely event of the check valve failure. Both of these disclosures provide for a sub-atmospheric delivery device that is located upstream of a valve seat with regard to the flow of gas through a valve. It is believed that these disclosures provide a device with significant limitations regarding the maximum inlet pressure (or cylinder storage pressure). This pressure must be at or below approximately 600 psig.

A third method for solving the problems associated with the sub-atmospheric delivery of dopant gases involves the use of a regulator (or regulators) to deliver product at sub-atmospheric conditions. The regulator(s) is pre-set to deliver product at a specific sub-atmospheric pressure. The regulator(s) is located upstream of the cylinder on/off valve seat and can be located in the cylinder neck cavity or inside the cylinder itself. U.S. Pat. Nos. 6,089,027 and No. 6,101,816 are both related to a fluid storage and dispensing system comprising a vessel for holding gases at a desired pressure. The vessel has a pressure regulator, e.g., a single-stage or multi-stage regulator, associated with a port of the vessel, and set at a predetermined pressure. A dispensing assembly, e.g., including a flow control means such as a valve, is arranged in gas/vapor flow communication with the regulator, whereby the opening of the valve effects dispensing of gas/vapor from the vessel. The fluid in the vessel may be constituted by a liquid that is confined in the vessel at a pressure in excess of its liquefaction pressure at prevailing temperature conditions, e.g., ambient (room) temperature. In particular, the '027 patent discloses a multi-stage regulator on the upstream side of the valve control means.

The above patents disclose locating the regulating devices upstream of the valve seat with respect to the flow of gas from the interior of the cylinder to the delivery port. However, the regulating devices can be located in the valve body, in the neck cavity, inside the cylinder itself, or a combination of all three of these locations.

A fourth method for solving the problems associated with the sub-atmospheric delivery of dopant gases involves the use of a single regulator located downstream of the cylinder on/off valve, said regulator located within the valve body and designed to control/deliver the product sub-atmospherically. U.S. Pat. No. 6,314,986 discloses a modular gas control device for use with a compressed gas cylinder comprises a primary module and a secondary module mounted on the primary module. This patent discloses the use of a single regulator located downstream of the main cylinder shut-off valve. The regulator is located within the valve body and is adjustable to deliver any desired outlet pressure from sub- to super-atmospheric pressure. The shut-off valve has its internal and seat mechanism located upstream of the regulator. A single regulator is disclosed. There are certain potential problems associated with this method. For example, potential high leak rate and pressure rise in the event the regulator failure may occur. Also, the single regulator may have difficulty controlling flow over large inlet pressure ranges.

It is an object of this invention to limit or prevent the release of toxic gases in the event of a valve or conduit failure.

Another object of this invention is to enable the storage of higher pressures in the gas cylinders. The higher pressure provides a greater amount of product to be contained in the cylinder, thereby providing greater productivity and lower cost for the customer.

Another object is to provide greater protection from exposing the cylinder valve seat to air contamination.

Yet another object is to provide a pressurized gas cylinder even greater protection from exposing the pressurized gas to the atmosphere due to the limited flow capacity of the specialized capillaries.

### SUMMARY OF THE INVENTION

This invention is directed to an apparatus for controlling the discharge of pressurized fluids from the outlet of a pressurized vessel, the apparatus comprising: a) a port body for communication with the outlet of a pressurized tank defining a fluid discharge path; b) a cylinder valve fixed in or upstream of the port body and adapted for movement between a sealing position that blocks fluid flow through the fluid discharge path and an open position that permits fluid flow along the fluid discharge path; c) an upstream diaphragm dispensing device defining an interior volume isolated from the pressure condition upstream of the valve element and engaged with the valve element to control the movement of the valve element in a manner that retains the valve element in a sealed position until a pressure differential between the interior volume of the diaphragm and the interior of the port body moves the valve element to an open position; and d) a downstream diaphragm dispensing device defining an interior volume isolated from the pressure condition upstream of the valve element and engaged with the valve element to control the movement of the valve element in a manner that retains the valve element in a sealed position until a pressure differential between the interior volume of the diaphragm and the interior of the port body moves the valve element to the open position.

In another embodiment, the invention is directed to a cylinder and a valve assembly for containing pressurized fluid and controlling the discharge of pressurized fluid from the cylinder, the cylinder and valve assembly comprising: a) a cylinder having a cylinder opening; b) a port body adapted for sealing engagement with the cylinder opening; c) a fluid inlet port defined by the port body and located outside the cylinder; d) a fluid discharge path between the fluid inlet port and the fluid outlet port; e) a manually operated shut off valve for controlling fluid flow along the fluid discharge path, wherein the shut-off valve biases a cylinder valve into a sealing position that blocks fluid flow along the fluid discharge path and a plurality of sealed bellows, at least one located upstream and at least one located downstream of the cylinder valve along the fluid discharge path, the sealed bellows having one portion operably linked to a valve element to move the valve element to an open position when relative pressure between an interior and an exterior of the bellow expands the bellows and wherein the open position permits fluid flow along the fluid discharge path.

In yet another embodiment, the invention is directed to an apparatus for controlling the discharge of pressurized fluids form the outlet of a pressurized tank containing toxic hydridic or halidic compounds, the apparatus comprising: a) a container for holding a pressurized fluid in an at least partial gas phase; b) an outlet port for releasing pressurized gas from the container; c) a gas flow path defined at least in part by an outlet port for delivering gas from the container; d) a plurality of separate dispensing check valve devices wherein at least one is disposed upstream and at least one is disposed downstream of a cylinder valve; and e) a capillary device in the form of a flow restrictor in the gas flow path.

In this invention, the vessel or port body retains a shut-off valve which is actuated either manually, electrically (e.g., solenoid), pneumatically or magnetically to operate the cylinder valve. A packing in the conduit with a restricted flow path defines a portion of the fluid discharge path. This conduit includes capillary tubes having an internal diameter of 0.2 mm or less.

Additional objects, embodiments, advantages and details of the invention are described in the following detailed description of the preferred embodiments.

### BRIEF DESCRIPTION OF THE DRAWINGS

FIG. 1 is a schematic drawing of the cross-sectional view of the cylinder and head valve assembly incorporating the double check valve delivery valve assembly of this invention.

FIG. 2 is an schematic diagram of the alternative position of upstream check valve and the capillary flow restrictor in this invention.

### DETAILED DESCRIPTION OF THE PREFERRED EMBODIMENTS

The present invention relates to a multiple check valve dispensing devices within a delivery system. Preferably, the system is a vacuum delivery system, wherein the first dispensing device is located upstream of the flow control element (i.e., cylinder valve). The first device allows delivery of gas from interior of the cylinder once it is actuated.

An important aspect of this invention is the utilization of a second dispensing check valve device located downstream of the cylinder valve which is disposed within the valve body. This second dispensing device is designed to open (or deliver gas) under sub-atmospheric conditions, (i.e. the inlet to the dispensing device would be at a pressure greater than at the outlet of the dispensing device, and preferably the pressure at the inlet would be at or above atmospheric pressure while the outlet of the dispensing device would be at sub-atmospheric pressure). Naturally, the dispensing device, is not limited to vacuum delivery. The two dispensing devices can be configured to deliver gas from within the cylinder at any downstream pressure range including sub-atmospheric, atmospheric, and super-atmospheric pressures up to the maximum storage pressure of the cylinder.

The second dispensing device is placed in a position such that it would experience cylinder pressure only when the cylinder valve is open, thereby limiting the dispensing device's exposure to gas from within the cylinder. Another advantage is that the dispensing devices are small enough to fit within the conventional cylinder opening. Optionally, the dispensing device can be placed outside of the cylinder (e.g., customer use port) to allow for the device to be adjustable (i.e., the actuation range could be adjusted). The positioning of the dispensing devices, is such that one of the devices is located upstream of the cylinder valve while a second device is located downstream of the cylinder valve, resulting in the advantageous embodiment of this invention. More specifically, the location of the second dispensing device downstream of the cylinder valve is integral to the cylinder valve in that the dispensing device is permanently attached or is actually part of the cylinder valve itself.

The multi-dispensing system described herein is preferably provided in conjunction with capillary flow restrictor assembly. The restrictor assembly is designed to limit the flow of gas from the cylinder in the event of a failure of either mechanical device. This assembly is preferably located 1) between the first dispensing device and the cylinder valve or 2) upstream of the first dispensing device. The skilled artisan will recognize that the exact location of the restrictor assembly would be dependent on the particular application.

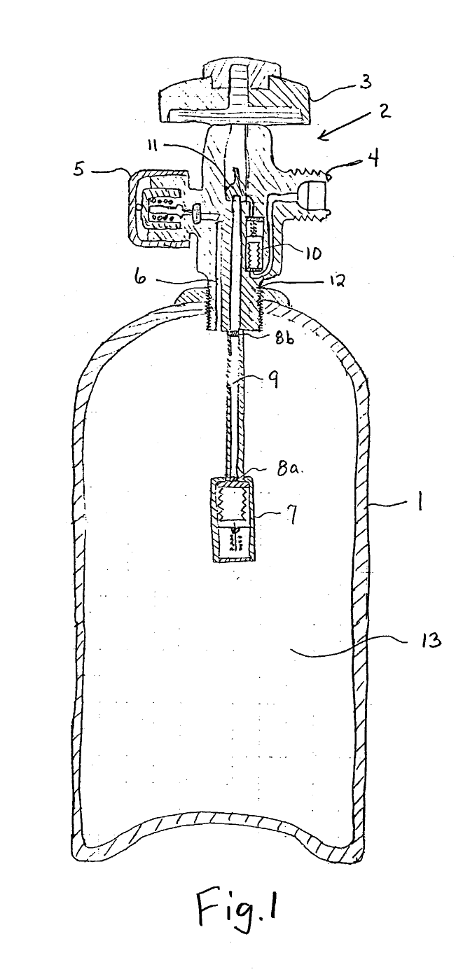

FIG. 1 illustrates an exemplary embodiment of the present invention, which achieves the objectives of sub-atmospheric delivery. At least one dispensing device 7 is disposed upstream of the shut off valve 3 (or cylinder valve 11) and one dispensing device 10 is disposed downstream of valve 3. This arrangement provides a system that eliminates the cylinder valve's exposure to air allows for greater packaging capacity, and utilizes capillary restrictors to limit the flow of the fluid to a low preset rate.

As depicted in FIG. 1, a multiple dispensing vacuum delivery valve assembly 2 with a larger than conventional outlet port body 4 or slightly larger than normal valve body is provided. Cylinder valve 11 is located within the valve body and downstream of a first dispensing device 7. Capillary assembly 9 is disposed between dispensing device 7 and cylinder valve 11.

The fluid storage and dispensing systems of a compressed gas cylinder 1 with multiple dispensing device vacuum delivery valve assembly 2 is shown. The compressed gas cylinder is filled with the desire fluid 13 (or in particular, dopant gas) to a given pressure or product weight.

Generally, the vacuum delivery valve assembly in this invention is applicable for a number of gaseous products. Table 1 below includes, but is not limited to, the fluids contemplated in this invention. Other fluids, particularly those including other inert, flammable, toxic or semiconductor process gases are within the scope of this invention.

TABLE 1

| | Cylinder | Desired | Optional |
|---|---|---|---|
| | Pressure | Downstream | Downstream |
| | (or Vapor | Delivery of | Delivery |
| | Pressure in | Pressure in | Pressure in |
| Gas or Fluid | psig) | torr | psig |
| Arsine | 205 | <760 | <205 |
| Boron | 600-1800 | <760 | <600 |
| Trifluoride | | | |
| Phosphine | 583 | <760 | <583 |
| Stibine | 780-1100 | <760 | <1100 |
| Silane | 1100 | <50 psig | <1100 |
| Diborane | 1000 | <760 | <1000 |
| Boron | 4.4 | <760 | <4 |
| Trichloride | | | |
| Halides | 0-1800 | <760 | <1800 |
| Germanium | 180 | <760 | <180 |
| Tetrafluorides | | | |
| Silicon | 1000 | <760 | <1000 |
| Tetrafluoride | | | |

Cylinder filling, conditioning and product testing takes place through the secondary fill port (not shown, but located behind the valve body when referring to FIG. 1). The fill port is opened and closed via a valve mechanism 5 and separate fill port 6. The customer use port 4 is opened/closed via a manual shut-off valve 3.

In a preferred embodiment, flow of gas is accomplished by applying a vacuum to the outlet port 4, which is in communication with the second dispensing check valve 10 and further upstream on the fluid discharge path with first dispensing check valve 7. The dispensing check valves of the present invention can be of the diaphragm type which include bellows. In particular, the diaphragm housing defines a bellow chamber that houses the bellows, wherein the bellows chamber communicates with a portion of the fluid discharge path located upstream of the valve element, and the bellows is sealed with sufficient interior pressure to move the valve element to the open position when communication within the discharge path produces a sufficient pressure condition in the bellows chamber.

The valve element includes a poppet valve and expansion of the bellows causes the pin to displace the poppet valve to an open position. One sealed bellows is located upstream and one bellows located downstream of cylinder valve 11, wherein each bellows is adapted to move the valve element to an open position in response to a pressure condition in the bellows chamber. The restricted passage can include capillary tubes containing packing that defines the fluid inlet port and locates the fluid inlet port about midway along the length of the cylinder and at the radial center of the cylinder interior.

Accordingly, with reference to FIG. 1, the application of a vacuum to outlet port 4 expands a bellows in the second dispensing check valve device 10 thereby moving the poppet from its seat and allowing gas to flow from the interior of cylinder 1 through the first dispensing check valve 7, through capillaries 9 and around the open cylinder valve 11. First dispensing device 7, which is disposed upstream of cylinder valve 11 is designed to open at pressure ranges less than or equal to the pressure inside the cylinder volume. The second dispensing check valve 10 provides vacuum delivery of the gas to the outlet port for use by a semiconductor tool. Additionally, frit filter devices 8A and 8B may be provided to remove particulate matter.

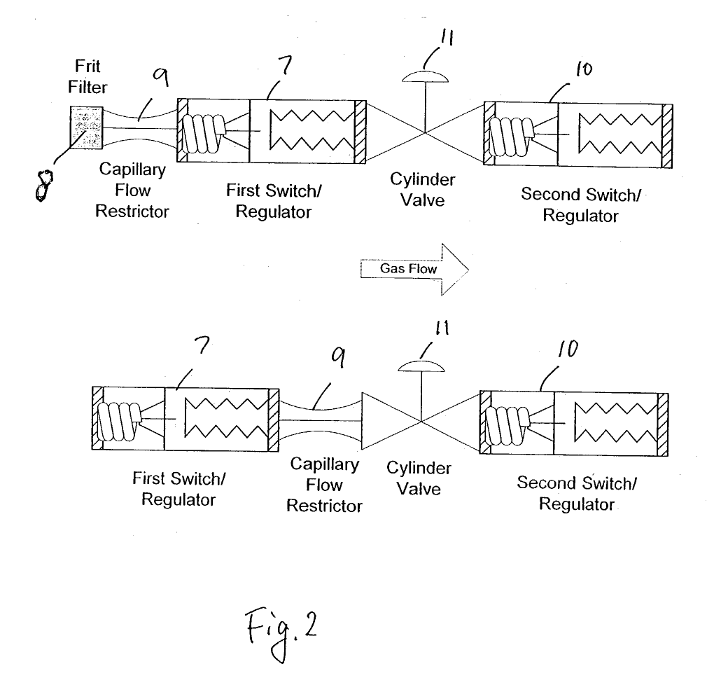

FIG. 2 illustrates a schematic diagram of the arrangement of the dispensing devices relative to the capillary assembly and the cylinder valve. In one exemplary embodiment, the capillary flow restrictor 9 is positioned upstream of dispensing check valve 7. Fluid passes downstream to cylinder valve 11 and then to downstream dispensing device 10. In another exemplary embodiment, the upstream dispensing check valve is positioned upstream of capillary flow restrictor 9, then the fluid passes on to cylinder valve 11 prior to downstream dispensing device 10.

Various elements and their operations not specifically discussed herein, including but not limited to the operations of the dispensing check valve devices and the capillary flow restrictors, may be found in U.S. Pat. Nos. 5,937,895; 6,045,115 and 6,007,609, and are incorporated herein by reference.

As discussed above, a key aspect to the invention is the utilization of at least two dispensing check valves and their location (i.e., the first device is disposed upstream and the second device is disposed downstream of the cylinder valve). The type of check valve can vary depending upon the gas utilized, actuation pressure, flow rate, etc. The second vacuum actuated dispensing check valve must be attached to the valve in a manner that provides a gas tight seal, and preferably is permanently attached to the valve. Most preferably, the dispensing check valve is disposed within the casting of the valve body itself. Placing the check valve at this location protects the check valve from being tampered with. Other configurations, however, are envisioned where a removable second dispensing device could be threaded or fastened in any other mechanical manner which would provide a gas tight seal.

A dispensing device could be inserted within the body of the outlet port similar to the manner in which a reducing flow orifice is installed in outlet ports. Since the second dispensing check valve is located exterior to the cylinder, provisions can be made to allow this device to be adjusted. Adjustment will change the actuation pressure range of this dispensing device to meet customer requirements. For instance, the dispensing device may be adjusted in a manner to change the downstream pressure range from sub-atmospheric to atmospheric or super-atmospheric ranges depending upon the customer's needs/application. As mentioned above, for this application the location of the two dispensing check valve devices is a critical aspect of the invention.

The multiple separate dispensing check valve devices in this invention facilitate the storage of higher pressures of gases in the vessel. Higher pressure provides greater opportunity to store more product (fluids or, gases) in equal volume, thereby providing lower cost of ownership to the customer. The multiple separate dispensing devices provide greater protection to the cylinder valve from air contamination as well as greater safety design should one of the dispensing devices fail.

In a separate embodiment, the modifications may also include a single dispensing device whereby the device is located at the valve and serves as both a dispensing check valve and a valve cylinder. Another adaptation of the invention involves the use of a single dispensing check valve device, which is located downstream of the cylinder valve. This dispensing device may be part of the cylinder valve body or be adaptable to being inserted into the outlet port as mentioned above. The location of this dispensing device would allow for adjustment of the device for delivery of gaseous product over a wide downstream delivery pressure range.

This invention also contemplates the particular use of a specialized shaped cylinder for certain gases or fluids to be stored and dispensed. In particular, the present invention provides for a significantly shorter and wider cylinder when storing and dispensing boron trifluoride. For example, such a cylinder may be 12 inches or less in length (exclusive of the neck), and 4.5 inches or less in outside diameter. The advantage associated with this type of cylinder is that a pressure relief valve is not necessary. Thus, an additional point of leakage on the apparatus is eliminated, further reducing the undesired potential release of gas.

The multiple dispensing check valve delivery system of the present invention will be further described with reference to the following example, which is, however, not to be construed as limiting the invention.

### EXAMPLE

A gas cylinder 1 was filled with boron trifluoride (BF₃)gas 13 to a pressure of about 1800 psig. The operator manually turned handle 3, which moved the cylinder valve 11 in an open position. The normally closed diaphragm dispensing check valves 10 and 7 were designed to open at a pressure of 400 torr or below (i.e. sub-atmospheric pressure) and 200 psig or below, respectively.

Vacuum was applied to gas cylinder 1, via outlet port 4, which was in communication with second dispensing check valve 10 and is disposed downstream of cylinder valve 11. The bellows in check valve 10 expanded and unseated the poppet in valve 10. As dispensing check valve 10 opened, the pressure along the fluid discharge path between second dispensing check valve 10 and first dispensing check valve 7 continued to drop below 200 psig to 100 psig.

As the pressure downstream of the first dispensing check valve 7 dropped below 200 psig, the bellows in check valve 7 expanded and unseated the poppet in valve 7.

BF₃ gas was removed through the fluid discharge path until the pressure in the path (i.e., between the first and second dispensing check valves) reaches 200 psig. Once the pressure reached the predetermined pressure (i.e., 200 psig) the bellows in the first dispensing check valve 7 contracted and the poppet closed, and the remainder of BF₃ gas in the fluid path was removed by the vacuum applied to the second dispensing check valve 10.

Those skilled in the art will recognize that numerous changes may be made to the process described in detail herein, without departing in scope or spirit from the present invention as more particularly defined in the claims below.

What is claimed is:

1. An apparatus for controlling the discharge of pressurized fluids from the outlet of a pressurized vessel, the apparatus comprising:
a. a port body for communication with the outlet of a pressurized tank defining a fluid discharge path;
b. a cylinder valve fixed in or upstream of the port body and adapted for movement between a sealing position that blocks fluid flow through the fluid discharge path and an open position that permits fluid flow along the fluid discharge path;
c. a upstream diaphragm dispensing device defining an interior volume isolated from the pressure condition upstream of the valve element and engaged with the valve element to control the movement of the valve element in a manner that retains the valve element in the sealing position until a pressure differential between the interior volume of the diaphragm and the interior of the port body moves the valve element to the open position; and
d. a downstream diaphragm dispensing device defining an interior volume isolated from the pressure condition upstream of the valve element and engaged with the valve element to control the movement of the valve element in a manner that retains the valve element in the sealing position until a pressure differential between the interior volume of the diaphragm and the interior of the port body moves the valve element to an open position.

2. The apparatus of claim 1 wherein said port body retains a shut-off valve utilized to operate the cylinder valve.

3. The apparatus of claim 1 wherein a conduit with a restricted flow path defines a portion of the fluid discharge path.

4. The apparatus of claim 3 wherein a packing in the conduit provides the restricted flow path.

5. The apparatus of claim 3 wherein the conduit comprises a capillary tube having an internal diameter that does not exceed 0.2 mm.

6. The apparatus of claim 1 wherein the diaphragm is a bellows.

7. The apparatus of claim 1 wherein a housing defines a bellow chamber of said upstream diaphragm, the bellows chamber communicates with a portion of the fluid discharge path located downstream of the valve element, and the bellows is sealed with sufficient interior pressure to move the valve element to the open position when communication with the discharge path produces a vacuum condition or pressure differential within the bellows chamber.

8. The apparatus of claim 7 wherein the valve element comprises a poppet valve and expansion of the bellows causes the pin to displace the poppet valve to an open position.

9. A cylinder and a valve assembly for containing pressurized fluid and controlling the discharge of pressurized fluid from the cylinder, the cylinder and valve assembly comprising:
a cylinder having a cylinder opening;
a port body adapted for sealing engagement with the cylinder opening;
a fluid inlet port defined by the port body and located outside the cylinder;
a fluid discharge path defined by the valve body between the fluid inlet port and the fluid outlet port;
a manually operated shut off valve for controlling fluid flow along the fluid discharge path;
wherein said manually operated shut-off valve biases a cylinder valve into a sealing position that blocks fluid flow along the fluid discharge path and a plurality of sealed bellows, at least one located upstream and at least one located downstream of the cylinder valve along the fluid discharge path, the sealed bellows having one portion operably linked to a valve element to move said valve element to an open position when relative pressure between an interior and an exterior of the bellow expands the bellows and wherein the open position permits fluid flow along the fluid discharge path.

10. The apparatus of claim 9 wherein the port body includes a bellows chamber that houses the bellows.

11. The apparatus of claim 9 wherein the bellows is adapted to move the valve element to an open position in response to a vacuum condition or pressure differential in the bellows chamber.

12. The apparatus of claim 9 wherein the valve element comprises a poppet valve.

13. The apparatus of claim 9 wherein the port body includes a restricted passage along the length of the fluid discharge path.

14. The apparatus of claim 13 wherein a capillary tube defines the fluid inlet port and locates the fluid inlet port about midway along the length of the cylinder.

15. The apparatus of claim 14 wherein the capillary tube retains the inlet tube at about the radial mid-point of the cylinder.

16. An apparatus for controlling the discharge of pressurized fluids from the outlet of a pressurized tank containing toxic hydridic or halidic compounds, the apparatus comprising
a container for holding a pressurized fluid in an at least partial gas phase;
an outlet port for releasing pressurized gas from the container;
a gas flow path defined at least in part by an outlet port for delivering pressurized gas from the container; and
a plurality of separate dispensing check valve devices, at least one upstream and at least one downstream of a cylinder valve, and a flow restrictor.

17. The apparatus of claim 17 wherein a conduit located within the container includes the restricted portion of the flow path.

18. The apparatus of claim 18 wherein a packing in the conduit provides the restricted flow path.

19. The apparatus of claim 18 wherein the restricted flow path comprises a capillary tube having an internal diameter that does not exceed 0.2 mm.

20. The apparatus of claim 1, wherein the apparatus does not contain a pressure relief valve.
